(19) United States
(12) Patent Application Publication
(10) Pub. No.: US 2014/0154367 A1
(43) Pub. Date: Jun. 5, 2014

(54) DELIVERY OF FLAVORS IN MICROWAVE POPCORN BAGS

(71) Applicant: Young Kang, Alpharetta, GA (US)

(72) Inventor: Young Kang, Alpharetta, GA (US)

(21) Appl. No.: 13/705,073

(22) Filed: Dec. 4, 2012

(51) Int. Cl. B65D 81/34; A23L 1/18

(52) U.S. Cl. CPC B65D 81/3469; A23L 1/1812
USPC 426/107

(57) ABSTRACT

Disclosed are microwave popcorn articles comprising any conventional microwave popcorn bag, and a food charge disposed therein comprising kernel popcorn, an edible oil or fat, and a flavoring container containing a heat-sensitive flavoring. During popping, the flavoring container is maintained at relatively low heat and opens during process to provide flavoring to the popping corn.

### RELATED APPLICATIONS

This application claims the benefit of U.S. provisional application 61/249,555 filed on Oct. 7, 2009, which is hereby incorporated herein in its entirety for all purposes.

### FIELD

The present invention relates to packaged food products and to their methods of preparation. In particular, the present invention relates to microwave popcorn product articles for flavored popcorn and to methods for filling such articles.

### BACKGROUND

Popcorn is a highly popular snack food item. In the past, the at-home preparation of popcorn by the consumer involved adding kernel popcorn plus a cooking oil to a covered pot and heating until the popcorn kernels popped to make popcorn. As used herein, “kernel popcorn” refers to unpopped popcorn. The noun “popcorn” or synonymously “popped popcorn” refers herein to popped kernel popcorn. The adjective “popcorn” can refer to either. Once prepared, common, relatively coarse, table salt is a frequently added flavoring or condiment. The resultant salted popped popcorn is a familiar snack food.

More recently, microwave popcorn products have become extremely popular. At present, in the U.S., over 70 different brands of microwave popcorn products are available. In general, the more popular microwave popcorn products comprise an expandable paper bag containing a charge of kernel popcorn, and optionally fat and/or salt. The microwave popcorn article is adapted to be heated in a microwave oven for three to five minutes to produce the popped popcorn. More recently, improved microwave popcorn articles have been fabricated employing a metallized susceptor which facilitates the heating of the kernel popcorn-fat charge and which, in turn, leads desirably to increases in popcorn volume and decreases in unpopped kernels. Microwave popcorn articles of this type are described in detail in, for example, U.S. Pat. No. 4,450,180 (issued May 22, 1984 to J. D. Watkins and incorporated herein by reference).

The fat component is generally flavored with artificial butter flavor although microwave popcorn with real butter products are known and commercially available (see U.S. Pat. No. 5,919,505 “Shelf-Stable Butter Containing Microwave Popcorn Article and Method of Preparation” issued Jul. 6, 1999 to Monsalve et al.).

Sweet popcorn products or “kettle corn” popcorn are well known. Among these, caramel popcorn has long been a popular food item. Such products generally comprise a sweet coating, typically from sucrose and/or small amounts of brown sugar and/or sugar based syrups such as molasses or black strap sugar syrup to provide a caramel flavor and that can also contain butter and/or other fat(s). Bulk amounts of popcorn are prepared (sometimes admixed with nuts) and the sugar-based coating is applied thereto by manufacturers to make the caramel popcorn. Quantities are provided in suitable consumer packaging such as bags whether or not in cartons or other suitable containers, e.g., plastic tubs. Various amounts of salt are added to provide a merely sweet to a sweet-and-salty flavor. With lesser amounts of coating, the coated popcorn can be free flowing. With more coating, agglomerated pieces or even popcorn balls are made.

Microwave products for preparing sweetened puffed products are known (see for example U.S. Pat. No. 4,409,250 to Van Hulle et al.). However, sweet microwave puffed products comprising sugars can exhibit scorching or even runaway heating due to the high microwave absorption by sugars and salt and the low browning or burning temperatures of sugar. (For a description of such problems, see, for example U.S. Pat. No. 5,443,858 “Composition For Sweetening Microwave Popcorn; Method And Product” issued Aug. 22, 1995 to Jensen, et al.). In extreme cases, the microwave bag can actually ignite due to the burning sugars. Sugar scorching problems are aggravated by salt, making provision of “sweet and salty” products (i.e., products having a more pronounced salt flavor due to higher levels of salt) especially difficult. The excessive heat can also scorch the popcorn.

One approach for providing a microwave popcorn product having a sweet or cheese coating that does not scorch or burn during microwave popcorn popping is to separately package the coating from the microwave popcorn for post popping addition thereto (see for example, U.S. Pat. No. 4,904,488 “Uniformly-Colored, Flavored, Microwaveable Popcorn” issued Feb. 27, 1990 to LaBaw et al.).

Another approach is described in U.S. Pat. No. 5,443,858 “Composition for Sweetening Microwave Popcorn; Method and Product (issued Aug. 22, 1995 to Jensen et al.). The '858 teaches a microwave popcorn article including a food charge formulated to include in addition to popcorn ingredients for forming a coating to the popped popcorn. The coating feature ingredients are selected to include a low moisture coarser granulation sugars in combination with selection of a low melting point oil and salt and moisture level control to provide a microwave sweet popcorn product.

Another technique for providing a sweet microwave popcorn product is to employ in substitution for low temperature burning temperature sugars a sweetening agent that exhibits greater tolerance to higher temperatures such as acetylsulfame K and/or Sucralose. Sucralose was not approved for use in microwave popcorn products in the United States until August 1999 when sucralose was approved for use for all food categories. Soon thereafter, several microwave popcorn manufacturers began marketing sweet or “kettle corn” microwave popcorn products (see for example, published US patent application US 2002/0127306 “Sweet and Salty Microwave Popcorn Compositions; Arrangements and Methods”). Such products generally employ low levels of the intensely sweet sucralose typically dispersed or diluted in small amounts of a heat tolerant powdered carrier or diluent such as a maltodextrin and avoid inclusion of temperature sensitive sugar ingredients. While useful, the sweetened microwave popcorn prepared from such microwave popcorn products lack the quantity of coating or glaze typical of bagged popped caramel popcorn and thus the eating qualities of such heavily coated sweet products. Also, sucralose is a high value, high cost ingredient.

The discussion above focuses on sweetened popcorn, but similar issues arise with other flavorings. As mentioned briefly above, cheese flavorings are difficult to achieve in microwave popcorn because of scorching. Many other flavorings change dramatically when subjected to high temperatures for long periods; even if actual scorching does not occur, off-notes and other disfavored flavor qualities can result through heat abuse, and in some cases the intensity of flavors is reduced through overheating.

Thus, there is a continuing need for new and useful microwave popcorn products that can be used to provide flavored popcorn while minimizing undesirable scorching and heat abuse effects.

### BRIEF SUMMARY

In its article aspect, the present microwave popcorn articles essentially comprise a microwave popcorn bag and food charge dispersed therein. The food charge comprises kernel popcorn in a slurry that includes at least one edible oil or fat, and optionally certain heat-tolerant flavorings and colorings. In addition, the food charge also includes at least one flavoring that is not in the slurry, but instead is in separate packaging that is also within the food bag. Unlike the slurry, which is conventionally located in close proximity to a susceptor portion of the bag at which microwave heating energy is concentrated, the flavoring container is further away from the susceptor and therefore its contents absorb less heat than they would if included in the slurry. The flavoring container intentionally fails during the popping process, thereby delivering its contents to the popping corn.

### BRIEF DESCRIPTION OF THE DRAWINGS

FIG. 1 is a perspective view of an unsealed partially folded microwave popcorn bag ready for filling.

FIG. 2 is a cutaway view of a microwave bag with a food charge as described herein.

### DETAILED DESCRIPTION

The discussion herein relates to consumer packaged food items for the microwave preparation of flavored popcorn and to their methods of preparation and use. Each of the product components as well as product use and attributes and methods of their preparation are described in detail below.

Throughout this document, percentages are by weight and temperatures in degrees Centigrade unless otherwise indicated. Each of the US patents and US patent applications referenced herein are hereby incorporated by reference.

The improvement described herein relates to microwave popcorn articles with a flavoring ingredient to provide the finished popcorn with a flavored coating and to their methods of preparation. The present microwave popcorn articles essentially comprise a microwave popcorn container such as a bag and a food charge disposed within the bag, said food charge comprising a quantity of 1) kernel popcorn; 2) a slurry including at least one edible oil or fat, and optionally flavoring ingredients that are relatively insensitive to heat; and 3) a flavoring container containing heat-sensitive flavoring ingredients. Each of these article components as well as methods of filling, product use and attributes are described in detail below.

### Microwave Container

The present microwave popcorn articles essentially comprise a conventional microwave popcorn popping container. Useful microwave containers herein can include any container for microwave popcorn products presently known in the art or developed in the future. Cardboard tubs have also been recently developed for microwave popcorn articles and can be used as the microwave container. Particularly useful herein for the microwave popping container are a wide variety of commercially available microwave bags for microwave popcorn.

For example, a suitable bag widely used commercially and preferred for use herein is described in U.S. Pat. No. 4,450,180. A generally similar bag is described in U.S. Pat. No. 4,548,826 or in U.S. Pat. No. 4,973,810 “Microwave method of popping popcorn and package therefor” issued Nov. 27, 1990 to Arne Brauner. Also useful are structures described in U.S. Pat. Nos. 4,735,513 and 4,878,765. Generally, the bag therein described comprises and is fabricated from a flexible sheet material having two collateral tubular sections. The sections are parallel longitudinally extending that communicate with each other at the center of the package.

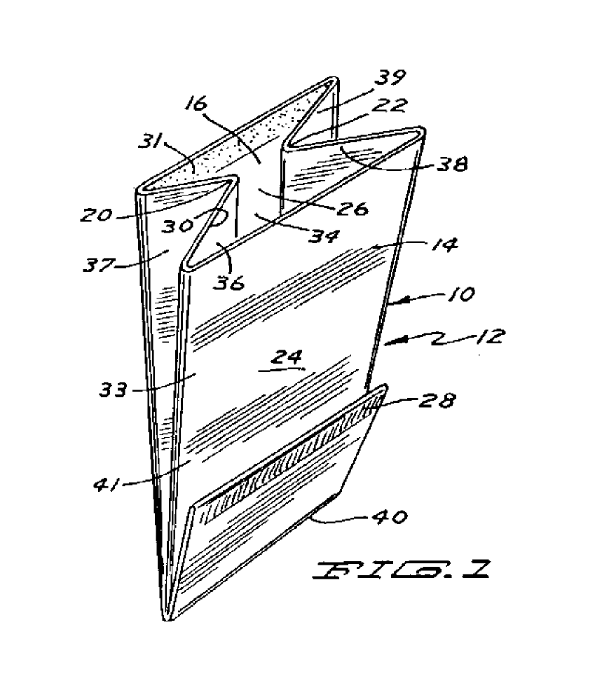

Referring now to FIG. 1, there is shown an embodiment of a microwave popcorn article 10 composed of a microwave bag 12 formed from flexible sheet material such as paper and being of collateral tubular configuration, that is to say, being composed of a pair of parallel longitudinally extending tubes 14 and 16 which communicate with one another along a central longitudinal opening. The two parallel tubes 14 and 16 are separated by longitudinally extending side indentations 20 and 22. When the package comprises a paper bag, the bag can be composed of first and second face panels 24 and 26 respectively and the indentations 20 and 22 comprises gussets. When in a vertically aligned orientation, the bag has a bottom seal 28 and initially an open top or orifice 30 but a sealable seal area 31 that transversely extends the open sealable top. The sealable area can include a heat activated adhesive or a “cold seal” adhesive, as is convenient. After being filled, the top 30 is also sealed conventionally by means of heat or other suitable adhesive to provide a top seal in the top seal area 31.

The bag material is generally fabricated with multiple plies including an outer ply 33 which is generally paper, a grease-proof or resistant inner ply 34 and microwave susceptor film member or ply intermediate these inner and outer paper layers. However, in preferred embodiments the microwave susceptor is present only on one major face panel. The microwave susceptor provides supplemental heating for heating the food charge to cause popping of the popcorn.

While tubes (or chambers, or channels) 14 and 16 can be of equal size, conventionally the susceptor channel 16 is generally slightly smaller. In such a configuration, the gussets include major left gusset face 36, minor left gusset face 37, major right gusset face 38 and minor right gusset face 39. The bag 12 can be provided with a lower transverse fold 40 to define an intermediate portion or pocket 41.

Although in the present description, a particular description is given to this preferred microwave bag, the present improvement is also useful in connection with, for example, flat bottomed bags, bags with or without a bottom fold, with a straight bottom seal or other more complex bottom seal designs. Also, the present methods can be employed using new and improved microwave popcorn bag designs.

Since introduction, microwave popcorn bags have undergone continued development generally directed towards cost reduction, especially of the expensive microwave susceptor component. Also, improvements continue to be made (see for example U.S. Ser. No. 09/943,637 “EASILY EXPANDABLE, NONTRAPPING, FLEXIBLE PAPER, MICROWAVE PACKAGE” filed Aug. 31, 2001 by Monforton) to improve popping performance or to facilitate commercial manufacturing at lower cost or at higher packaging line speeds.

While particular attention is given to microwave bags herein as the preferred microwave container, the skilled artisan will appreciate that the present article is broadly useful when used with a variety of packaging and disposable microwave containers.

### Popcorn

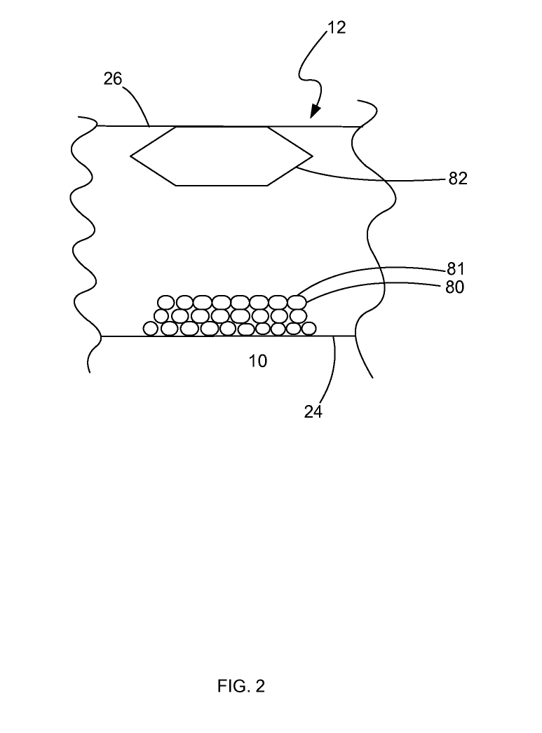

Referring now also to FIG. 2, the present article 10 further includes a food charge 80 disposed within the bag 12. The food charge essentially includes a quantity of kernel popcorn either mixed in with or adjacent to a slurry 81 including an edible oil or fat, and optionally other ingredients such as flavorings; and a separate flavoring container 82 containing a relatively heat sensitive flavoring ingredient. The food charge 80 can comprise from about 30 to 150 g in a microwave bag for example. For single serve products, the food charge 80 can be smaller and can comprise about 30 to 100 g. For regular sized products, the food charge 80 can comprise about 50 to 150 g, preferably about 100 to 130 g.

Conventionally, microwave popcorn food charge formulations are expressed based upon the weight of the entire kernel popcorn and food charge. This convention is followed herein. Broadly, the popcorn can range from about 30 to 90% of the popcorn charge. Typically, about 15 to 100 g of kernel popcorn is added to the bag, preferably about 50 to 70 g/bag for regular sized products and about 25 to 40 g/bag for “single portion” sized products. In general practice, the amount of kernel popcorn is set and the other ingredients are varied to provide variations such as full fat, reduced or low fat, and/or salted or low salt embodiments.

Generally, microwave popcorn is dried to moisture contents ranging from about 10% to 18%, preferably about 12% to 16% and for best results about 14% to insure sufficient moisture for popping of a high fraction of kernels while minimizing moisture that might cause or promote bacterial growth during the long term distribution and storage characteristic of shelf stable packaged products. It should be noted that some flavorings are intolerant to moisture, whether during storage or popping, so containing them separately from the other ingredients of the popcorn bag as described herein can help retain quality and intensity of such flavors.

Conventional kernel popcorn varieties can be used and are preferred for use herein. Also useful herein are relatively larger kernel popcorn varieties for providing “Jumbo Pop” products as well as “mushroom” sized popcorn which is commonly used for ready-to-eat popcorn snack products. Useful are those larger varieties having a kernel count up to 60 kernels per 10 g, preferably less than 55, which are commercially available.

In certain variations, the popcorn can be infused with materials, e.g., flavor or colors, intended to provide popcorn products of enhanced visual or flavor appeal. In other variations, the popcorn can be bred to provide natural color and/or flavor variations.

Additionally, all or a portion of the microwave popcorn can be substituted with expandable or microwave puffable pellets such as are descried in the '250 patent to Van Hulle. Also useful herein are those products described in U.S. Pat. No. 5,102,679 “Half products for microwave puffing of expanded food product” issued Apr. 7, 1992 to Whelan. See also U.S. Pat. No. 6,083,552 “Microwaveable Popcorn Product And Method” issued Jul. 4, 2000 to Kershman et al. In certain variations comprising a blend of kernel popcorn and puffable pellets, weight ratio of the kernel popcorn to puffable pellets can range from about 10:1 to about 1:10, preferably about 1:4 to about 4:1 and for best results about 1:3 to about 3:1.

### Heat Sensitive Flavorings

The microwave food charge 80 additionally comprises a heat sensitive flavoring in flavoring container 82. In practice it has been found that, conventionally, sugar, salt, cheese and other common flavorings used in combination with microwave popcorn can in certain combinations result in significant problems with burning. Certain flavoring oils react with other food ingredients, as well as oxygen, over time and lose their intensity, develop off-notes, or otherwise deteriorate. As shown for example in FIG. 2, flavoring container 82 is disposed in a manner such that much of the flavoring within the container is relatively distant from the face panel 24 including the susceptor of bag 12, thus resulting in less heat being transferred to the flavorings within container 82 than if they were mixed in with slurry 81. As illustrated in FIG. 2, the flavoring container 82 is attached to face panel 26. In this embodiment, the microwave susceptor is preferably present on the opposite face panel 24.

In one embodiment, flavor container 82 is implemented as a gelatin-based capsule such as used in pharmaceuticals. The addition of heat, the resulting expansion of the contents of container 82, and the mechanical impact of the popping process all serve to weaken container 82, eventually causing it to fail and deliver the flavoring to the popping corn. In one specific embodiment, a portion of the container 82 is fastened to bag 12 so that upon failing the capsule is maintained captive and not mixed in with the popped popcorn. In a still more specific embodiment, container 82 is a gelatin-based capsule formed in the shape of a flat patch on an inside portion of bag 12 that during popping increases in distance from susceptor channel 16.

In some embodiments, microwave shielding, such as described in U.S. Pat. Nos. 6,231,903 and 6,259,079 is placed around flavoring container 82 to further limit heating of the flavorings therein.

As mentioned above, isolating sensitive flavors in container 82 reduces the exposure of such flavors to heat and moisture, thereby allowing greater consistency, quality, and balance of flavors regardless of storage time, popping conditions, and the like. With certain flavorings, such isolation also allows flavors to be more intense, as over-heating can dull some flavor types. Therefore, smaller quantities of flavorings are required to yield the same consumer experience, resulting in lower cost, reduced popping time, lower product shipping weights, and reduced waste. This formulation is found not to result in microwave burning problems. Increasing amounts of such slurry formulations likewise do not exhibit burning.

A second embodiment uses other containers, such as a miniature version of bag 12, as container 82. Such containers are configured to release contents through any combination of heat, internal pressure or mechanical agitation, as may be appropriate. For example, a powdered or granulated cheese or garlic flavor may be beneficially stored in a paper laminate container attached on one side to bag 12 that becomes stretched and opens when bag 12 expands during popping, thereby releasing its contents onto the popping corn.

### Method of Preparation

Broadly, the present methods of preparation include the steps of adding the food charge to an at least partially open microwave popping container to form a filled container and sealing the filled container to provide a microwave popcorn article product.

The flavoring container 82 may be filled and attached to the bag 12 prior to the food charge being added. Alternatively, the flavoring container is filled and attached to the bag 12 after the food charge is added and before sealing the filled container. In yet another embodiment, the container 82 is attached to the bag 12 prior to the flavoring being added.

In one variation, the food charge is formed in a single composite mass such as a toroid or ring and the composite mass charged to an open microwave popcorn bag or other container prior to final sealing. (See for example U.S. Pat. No. 4,450,180, issued May 22, 1984).

In another variation one or more ingredients are added separately to the open microwave bag. For example, microwave bags having an unsealed open end and a folded lower portion are advanced to a first kernel popcorn filling station. While being maintained in an open position, the loose kernel popcorn is charged to the desired channel in desired amounts to form partially filled bags containing kernel popcorn. The kernel popcorn is added first to facilitate more even distribution of the balance of ingredients over the popcorn to thereby provide a finished popcorn having a more even distribution of the coating ingredients. In those variation that include puffable pellets other than or in admixture with kernel popcorn, the puffable pellets or popcorn-and-pellet mixtures are likewise first added to the microwave popcorn bag.

Thereafter, the partially filled bags are advanced to a second filling station at which a slurry is added to the bag. Typically, the slurry is added in the form of a vertically dispensed pencil jet (i.e., a confined stream) of the slurry. (See, for example, U.S. Pat. No. 4,604,854 entitled “Machine For Forming, Filling and Sealing Bags,” issued Aug. 12, 1986 to D. W. Andreas). The slurry contains the fat ingredient(s), is typically heated to melt a solid fat to liquid or fluid form, and optionally includes flavors, colors, etc. For those embodiments comprising salt in flour form, the slurry can include all or a portion of the flour salt.

Single station filling methods are also known that involve applying the fat/salt slurry as a spray onto the kernel popcorn as the kernel popcorn falls into the bag. (See, for example WO 95/01105 entitled “Reduced Fat Microwave Popcorn and Method of Preparation” published Jan. 12, 1995, or, equivalently, U.S. Pat. No. 5,690,979 issued Nov. 25, 1997; or U.S. Pat. No. 5,171,950 “Flexible Pouch and Paper Bag Combination For Use In The Microwave Popping of Popcorn” issued Dec. 5, 1992 to Brauner et al.) which is incorporated herein by reference. Such single station filling techniques are especially useful for the preparation of low fat microwave popcorn products. In this variation, optional isomalt in powder form can be added to the popcorn filling funnel along with the popcorn, e.g., after the popcorn has been charged to the bag. In such an embodiment, heat-sensitive flavorings are in a separate container that is already present in the bag or is added after this station but before sealing.

The bags now containing both kernel popcorn and slurry and other ingredients are then advanced to a sealing station where the bags are provided with a top seal to complete the closure of the bag. The sealed popcorn bags are advanced to subsequent finish packaging operations that complete the folding of the bags, providing the bags with an overwrap, and inserting appropriate numbers of the bags into cartons, etc.

The term slurry is used herein as is common in the microwave popcorn art to refer to any coating applied to the kernel popcorn. The term “slurry” as used generally herein thus includes fat alone; fat and a lesser portion of salt in flour form; fat, flour salt, flavors and/or color or sweetener(s); fat, a portion of the flour salt and a portion of the calcium ingredient; and fat and substantially all of the calcium ingredient as well as any other variation or combination of ingredients used as an addition to the kernel popcorn herein.

The slurry can additionally optionally comprise minor amounts of other materials employed to make the microwave popcorn more aesthetically or nutritionally or organoleptically appealing. Such adjuvant ingredients can include, for example, limited amounts of sugar(s), micro fortification levels of minerals, vitamins, colorants, preservatives and flavors. If present, each of these constituents can comprise from about 0.01 to about 2% by weight of the fat slurry.

Especially popular for use herein is a butter flavor. The flavors can be either in liquid, fat soluble forms and/or in dry powder forms such as a liquid oil absorbed onto a particulate carrier, e.g., gum arabic, starch, silicon dioxide, or dehydrated cheese solids or in the form of an oil suspension.

The fat slurry is prepared simply by admixing the fat (in a fluid or melted state) together with any optional ingredients with salt and blending the mixture to form a stable dispersion or slurry. The fat or slurry, while still fluid (70° to 130° F.; 21° to 55° C.), is then sprayed into the microwave popcorn bag as described in detail below.

The slurry application step can be practiced by employing an applicator for spraying the fat slurry (e.g., commercially available from Hibar Systems Limited, Ontario, Canada) that is supplied by a slurry supply means. The slurry supply means can conveniently include a conventional positive displacement reciprocating metering pump having a piston and a pressurized slurry inlet. The pump precisely pumps metered amounts of the fat slurry to the applicator at closely controllable time intervals.

If the slurry viscosity is too high, the slurry becomes unpumpable. The concentrations of salt and calcium ingredients are selected such that the slurry has a viscosity of less than 10,000 cps, preferably less than about 1,000 cps, and, for best results, less than 300 cps.

The slurry can be added at temperatures ranging from about 15.5° to 65.5° C. (60° to 150° F.), preferably about 38° to 54.4° C. (100° to 130° F.).

While a pencil jet spray is preferred for use herein, equivalents thereof in terms of dispensing the slurry can also be used. For example, a multiplicity of very fine jet streams, (e.g., 3-12), or a sparge can be used to achieve the desired dispersion hereunder. Also, other spray types, (e.g., a cone spray, a mist spray, or a fan spray) are useful herein. However, great care must be taken in selecting such useful alternatives so as to avoid getting slurry in the bag seal area. In other embodiments, the spray can be gas assisted, e.g., air, steam, or inert gas.

In preferred embodiments, the bag 12 has a microwave chamber (i.e., wherein one major face panel has an intermediate microwave susceptor layer between the inner and outer bag layers) and, for cost considerations, a microwave susceptor-free chamber. In the preferred practice, the kernel popcorn, fat slurry and particulate(s) are charged to the microwave channel. Conventionally, the microwave channel is the lesser channel (i.e., being formed by the smaller major face 24) and the greater channel is the microwave free channel. Such a configuration minimizes the amount of relatively expensive microwave susceptor material required while nonetheless providing the needed expansion volume upon microwave popping. Further more, such a configuration allows for the heat-sensitive flavorings in the flavor container 82 to be affixed to the microwave free channel formed by face 26. Being relatively distant from the microwave channel protects the heat-sensitive flavorings from excessive heat which would reduce the quality of the flavorings.

In the preferred form, the popcorn charging and slurry addition are practiced at separate stations and as separate steps. However, in other embodiments, the kernel popcorn and slurry addition can be practiced in a single station concurrently. Apparatus and techniques for such concurrent filling of the popcorn and slurry are described in commonly assigned U.S. Pat. No. 5,690,979 (issued Nov. 25, 1997) entitled “Method Of Preparing Reduced Fat Microwave Popcorn.”

If high levels of salt and calcium ingredients are desired in the finished products, addition of the total quantity of each of these materials to the slurry will cause the slurry viscosity to be excessively high. That is, while the slurry may be able to carry all of the salt or all of the calcium ingredient, or half of each, the slurry cannot carry all of both. Thus, either all of the salt or all of the calcium ingredient or a portion of each (e.g., 50:50 or 70:30) must be added as dry particulates in a third filling station. Useful herein for practicing this step are particulate metered feeding equipment that are commercially available such as are used for filling salt or sugar packets.

The present methods further essentially include a conventional finish step of sealing the open end of the microwave popcorn bag after the bag has been filled with the quantity of popcorn kernels, the fat slurry and the quantity of particulates.

### Product Use

The microwave popcorn products prepared as described can be used in a conventional manner for the at-home preparation of a popcorn flavored with heat-sensitive flavorings by microwave heating. Upon microwave heating of the sealed microwave popcorn article in a conventional home microwave oven, the resultant popped popcorn in the form of free flowing of individual substantially unagglomerated popped popcorn kernels exhibits excellent organoleptic attributes notwithstanding the flavoring and with minimal scorching or browning.

1. A microwave popcorn article comprising a microwave popcorn bag with contained therein a food charge comprising kernel popcorn and at least one edible oil and a flavoring container containing at least one heat-sensitive flavoring, the flavoring container designed to fail upon heating.

2. The microwave popcorn article of claim 1 further comprising at least one heat tolerant flavoring.

3. The microwave popcorn article of claim 1 wherein the microwave popcorn bag comprises a first face panel and a second face panel, the first face panel opposite the second face panel, wherein the first face panel comprises a susceptor and wherein the flavoring container is disposed in the microwave popcorn bag relatively distant from the first face panel.

4. The microwave popcorn article of claim 3 wherein the flavoring container is attached to the second face panel.

5. The microwave popcorn article of claim 4 wherein the flavoring container is attached to the second face panel such that upon failing, the flavoring container remains attached to the second face panel and does not mix with the food charge.

6. The microwave popcorn article of claim 1 wherein the flavoring container comprises gelatin.

7. The microwave popcorn article of claim 1 wherein the flavoring container further comprises microwave shielding.

8. The microwave popcorn article of claim 7 wherein the microwave shielding is placed around the flavoring container.
